(19) United States
(12) Patent Application Publication
(10) Pub. No.: US 2026/0338686 A1
(43) Pub. Date: Oct. 29, 2026

(54) OPTICAL SYSTEM FOR METROLOGY AND INSPECTION, METROLOGY AND INSPECTION APPARATUS INCLUDING THE SAME, AND METROLOGY AND INSPECTION METHOD

(71) Applicant: SAMSUNG ELECTRONICS CO., LTD., Suwon-si (KR)

(72) Inventors: Seunghoon HAN, Suwon-si (KR); Jaeduck JANG, Suwon-si (KR)

(73) Assignee: SAMSUNG ELECTRONICS CO., LTD., Suwon-si (KR)

(21) Appl. No.: 19/657,846

(22) Filed: Apr. 24, 2026

(30) Foreign Application Priority Data
Apr. 29, 2025 (KR) 10-2025-0056749

(51) Int. Cl. G01N 21/45

(52) U.S. Cl. CPC G01N 21/45; G01N 2201/0633

(57) ABSTRACT

Provided is an optical system for metrology and inspection, the optical system including a light source, an interferometer configured to separate the light emitted from the light source into reference light and signal light which is transmitted through a sample or reflected by the sample, a spatial light modulator (SLM) on a plane corresponding to an image plane of the sample in an optical path of the reference light or an optical path of the signal light, the SLM being configured to modulate at least one of a brightness distribution of an image of the sample or a brightness distribution of the reference light, and a detector configured to detect an interference pattern of the signal light and the reference light.

### CROSS-REFERENCE TO RELATED APPLICATION

This application is based on and claims priority under 35 U.S.C. § 119 to Korean Patent Application No. 10-2025-0056749, filed on Apr. 29, 2025, in the Korean Intellectual Property Office, the disclosure of which is incorporated by reference herein in its entirety.

### BACKGROUND

### 1. Field

The disclosure relates to an optical system for metrology and inspection, a metrology and inspection apparatus including the same, and a metrology and inspection method.

### 2. Description of Related Art

Semiconductor devices are manufactured by forming a fine nanostructure on a wafer. After semiconductor devices are manufactured, a measurement inspection for verifying a nanostructure thereof may be performed. In addition to semiconductor devices, various meta-surfaces or optical structures used in virtual reality systems or augmented reality systems may have nanostructures. The measurement inspection of nanostructures of the semiconductor devices or meta-surfaces is mainly performed by radiating (emitting) light toward the surface where the nanostructures are formed and analyzing reflected and/or diffracted light. However, in a frontside illumination method, when the overall height of a three-dimensional (3D) nanostructure increases, it may be difficult to concentrate light to the maximum in a structural region where a fine change occurs in the nanostructure.

### SUMMARY

One or more embodiments provide an optical system for metrology and inspection which has improved measurement precision and sensitivity by using a spatial light modulator (SLM) provided on an optical path of an interferometer.

One or more embodiments provide a metrology and inspection apparatus and a metrology and inspection method with improved measurement precision and sensitivity.

Additional aspects will be set forth in part in the description which follows and, in part, will be apparent from the description, or may be learned by practice of one or more embodiments.

According to an aspect of one or more embodiments, there is provided an optical system for metrology and inspection, the optical system including a light source, an interferometer configured to separate the light emitted from the light source into reference light and signal light which is transmitted through a sample or reflected by the sample, a spatial light modulator (SLM) on a plane corresponding to an image plane of the sample in an optical path of the reference light or an optical path of the signal light, the SLM being configured to modulate at least one of a brightness distribution of an image of the sample or a brightness distribution of the reference light, and a detector configured to detect an interference pattern of the signal light and the reference light.

The SLM may include an amplitude-SLM (A-SLM).

The interferometer may include a common-path interferometer.

The interferometer may include a common-path interferometer, and the common-path interferometer may include a diffraction grating and a spatial filter.

The interferometer may include a Mach-Zehnder interferometer.

The interferometer may include a Michelson interferometer.

The optical system may further include an illumination optical system configured to transmit light emitted from the light source to the sample, wherein the illumination optical system may include a collimating lens.

The interferometer may include a relay optical system, and the relay optical system may include a 4 f system configured to perform Fourier transformation.

The sample may include one of a reflective sample and a transmissive sample, and the SLM may include one of a transmissive SLM and a reflective SLM.

The SLM may be configured to be controlled based on the interference pattern.

According to another aspect of one or more embodiments, there is provided a metrology and inspection apparatus including a light source, an interferometer configured to separate the light emitted from the light source into reference light and signal light which is transmitted through a sample or reflected by the sample into reference light and signal light, a spatial light modulator (SLM) on a plane corresponding to an image plane of the sample in an optical path of the reference light or an optical path of the signal light, the SLM being configured to modulate at least one of a brightness distribution of an image of the sample or a brightness distribution of the reference light, a detector configured to detect an interference pattern of the signal light and the reference light, and a processor configured to control an operation of the SLM based on the interference pattern.

The SLM may include an amplitude-SLM (A-SLM).

The interferometer may include one of a common-path interferometer, a Mach-Zehnder interferometer, and a Michelson interferometer.

The metrology and inspection apparatus may further include an illumination optical system configured to transmit light emitted from the light source to the sample, the illumination optical system may include a collimating lens.

The interferometer may include a relay optical system, and the relay optical system may include a 4 f system configured to perform Fourier transformation.

The sample may include one of a reflective sample and a transmissive sample, and the SLM may include one of a transmissive SLM and a reflective SLM.

According to yet another aspect of one or more embodiments, there is provided a metrology and inspection method including emitting, by a light source, light, transmitting, through an illumination optical system, the light emitted from the light source to be incident on a sample, transmitting the light incident on the sample through the sample or reflecting the light incident on the sample by the sample, and outputting the light as signal light, adjusting, by a spatial light modulator (SLM), a brightness distribution on at least one of a plane of an image of the sample or a plane an image of reference light corresponding thereto, transmitting, by an interferometer, the reference light and the signal light to a detector, and detecting, by the detector, an interference pattern of the signal light and the reference light.

The metrology and inspection method may further include performing feedback control of the SLM based on the interference pattern.

The SLM may include an amplitude-SLM (A-SLM).

The interferometer may include one of a common-path interferometer, a Mach-Zehnder interferometer, and a Michelson interferometer.

### BRIEF DESCRIPTION OF DRAWINGS

The above and other aspects, features, and advantages of embodiments will be more apparent from the following description taken in conjunction with the accompanying drawings, in which:

FIG. 1 is a block diagram illustrating a configuration of an optical system for metrology and inspection and a metrology and inspection apparatus including the same according to one or more embodiments;

FIG. 2 is a conceptual diagram illustrating a process performed by a metrology and inspection apparatus according to one or more embodiments;

FIG. 3 is a diagram illustrating a detailed configuration of a metrology and inspection apparatus according to one or more embodiments;

FIG. 4 is a diagram illustrating a detailed configuration of a metrology and inspection apparatus according to one or more other embodiments;

FIG. 5 is a diagram illustrating a detailed configuration of a metrology and inspection apparatus according to one or more other embodiments;

FIG. 6 is a diagram illustrating a detailed configuration of a metrology and inspection apparatus according to one or more other embodiments;

FIG. 7 is a diagram illustrating a detailed configuration of a metrology and inspection apparatus according to one or more other embodiments;

FIG. 8 is a diagram illustrating a detailed configuration of a metrology and inspection apparatus according to one or more other embodiments;

FIG. 9 is a diagram illustrating a detailed configuration of a metrology and inspection apparatus according to one or more other embodiments;

FIG. 10 is a diagram illustrating a detailed configuration of a metrology and inspection apparatus according to one or more other embodiments;

FIG. 11 is a diagram illustrating a detailed configuration of a metrology and inspection apparatus according to one or more other embodiments;

FIG. 12 is a diagram illustrating a detailed configuration of a metrology and inspection apparatus according to one or more other embodiments; and

FIG. 13 is a flowchart illustrating a metrology and inspection method according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, with reference to the accompanying drawings, an optical system for metrology and inspection, a metrology and inspection apparatus including the same, and a metrology and inspection method will be described in detail. Like reference numerals refer to like elements throughout, and in the drawings, sizes of elements may be exaggerated for clarity and convenience of explanation. The embodiments described below are merely exemplary, and various modifications may be possible from the embodiments.

When a constituent element is disposed “above” or “on” to another constituent element, the constituent element may be only directly on the other constituent element or above the other constituent elements in a non-contact manner. As used herein, the singular forms “a,” “an” and “the” are intended to include the plural forms as well, unless the context clearly indicates otherwise. It will be further understood that the terms “comprise” and/or “comprising” used herein specify the presence of stated features or elements, but do not preclude the presence or addition of one or more other features or elements.

The use of the terms “a,” “an,” “the,” and similar referents in the context of describing the disclosure is to be construed to cover both the singular and the plural. Also, the operations of all methods described herein may be performed in any suitable order unless otherwise indicated herein or otherwise clearly contradicted by context. The disclosure is not limited to the described order of the steps.

In addition, terms such as “. . . portion,” “. . . unit,” “. . . module,” and “. . . block” stated in the disclosure may signify a unit to process at least one function or operation and the unit may be embodied by hardware, software, or a combination of hardware and software.

In addition, the connecting lines, or connectors shown in the various figures presented are intended to represent functional relationships and/or physical or logical couplings between the various elements. It should be noted that many alternative or additional functional relationships, physical connections or logical connections may be present in a practical device.

The use of any and all examples, or language (e.g., “such as”) provided herein, is intended merely to better illuminate the disclosure and does not pose a limitation on the scope of the disclosure unless otherwise claimed.

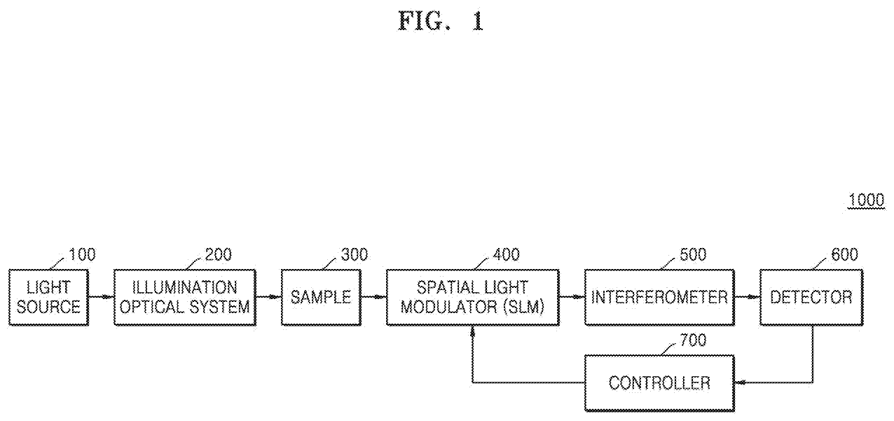

FIG. 1 is a block diagram illustrating a configuration of an optical system for metrology and inspection and a metrology and inspection apparatus including the same according to one or more embodiments.

Referring to FIG. 1, a metrology and inspection apparatus 1000 according to one or more embodiments may include a light source 100, an illumination optical system 200, a spatial light modulator (SLM) 400 (e.g., an amplitude-SLM (A-SLM)), an interferometer 500, and a detector 600. The metrology and inspection apparatus 1000 may further include a controller 700. The light source 100, the illumination optical system 200, the SLM 400, the interferometer 500, and the detector 600 may be included in the optical system for metrology and inspection.

The light source 100 may be, for example, a laser, a laser diode (LD), a light-emitting diode (LED), or a thermal light source. The illumination optical system 200 may include, for example, a collimating lens. The light source 100 and the illumination optical system 200 may provide illumination light to a sample 300 which is a measurement object. The illumination optical system 200 may collimate light emitted from the light source 100 to be transmitted as parallel light. The collimated parallel light may be incident on the sample 300. However, embodiments are not limited thereto, and, for example, the illumination optical system 200 may emit converging or diverging light toward the sample 300 rather than parallel light. The light incident on the sample 300 may be transmitted through the sample 300 or be reflected by the sample 300.

The SLM 400 may be provided on a plane corresponding to an image plane of the sample 300 on an optical path of signal light or reference light, and modulate a brightness distribution of the image of the sample 300. The SLM 400 may be, for example, a liquid crystal pixel array method, a microelectromechanical systems (MEMS) mirror array method (e.g., a digital micromirror device (DMD)), or another modulator array.

The parallel light incident on the sample 300 may be transmitted through the sample 300 or be reflected by the sample 300 to be directed to the SLM 400. The SLM 400 may modulate the brightness of a part of the image or the entire region of the image so that an interference pattern image has uniform fringe visibility over the entire region. The signal light and the reference light modulated by the SLM 400 may be directed to the interferometer 500.

The interferometer 500 may be, for example, any one of a common-path interferometer, a Mach-Zehnder interferometer, or a Michelson interferometer. The signal light and the reference light modulated by the SLM 400 may pass through the interferometer 500 to form an interference pattern.

The detector 600 may detect the interference pattern formed by the signal light and the reference light modulated by the SLM 400 through the interferometer 500. For example, the detector 600 may include an array detector. The detector 600 may set measurement conditions to increase precision quality such as a signal-to-noise ratio (SNR) by using a dynamic range. The interference pattern image measured by the detector 600 may be transmitted to the controller 700.

The controller 700 may include at least one processor. The controller 700 may be configured to control an operation of the SLM 400 and analyze the sample 300 based on the interference pattern. The controller 700 may convert the obtained interference pattern into phase information image data or complex phase information image data. The data converted by the controller 700 may be used for metrology and inspection of the sample 300. In addition, the controller 700 may perform feedback control based on the interference pattern. The controller 700 may control the SLM 400 based on the obtained interference pattern. The controller 700 may control an output amplitude of each pixel of the SLM 400 so that the brightness distribution of the interference pattern becomes uniform throughout based on the interference pattern of the signal light and the reference light obtained from the detector 600. For example, the controller 700 may iteratively correct a brightness histogram distribution of the interference pattern (iterative feedback loop). For example, the controller 700 may control the SLM 400 based on the interference pattern measured by the detector 600 to correct the brightness histogram distribution of the interference pattern, and may iteratively correct the brightness histogram distribution of the interference pattern by again controlling the SLM 400 based on the interference pattern corrected by controlling the SLM 400.

In addition, when modulating a reflection intensity or transmission intensity of the SLM 400, a reflection phase or a transmission phase may change according to a modulation level. The controller 700 may measure and calculate and/or obtain such a phase change in advance and reflect the measured and calculated and/or obtained phase change as calibration information when switching to a phase and a complex phase image after interference pattern imaging.

However, embodiments are not limited thereto, and the SLM 400 may correct the brightness histogram distribution by a non-iterative method, for example, by a predetermined value.

The sample 300 may include, for example, a three-dimensional (3D) nanostructure. The 3D nanostructure may include various optical or electronic components having structures of a micrometer or less, i.e., a nanometer scale. For example, the 3D nanostructure related to optical components may include various types of couplers used in an augmented reality (AR) device, a virtual reality (VR) device, an extended reality (XR) device, etc., a flat optics device, or structures for each process operation of manufacturing the couplers and the flat optics device. In addition, the 3D nanostructure may include various 3D memories, such as 3D dynamic random-access memory (DRAM), high bandwidth memory (HBM), vertical negative-AND (VNAND) flash memory, various integrated circuits, or structures for each process operation of manufacturing the 3D memories and the integrated circuits.

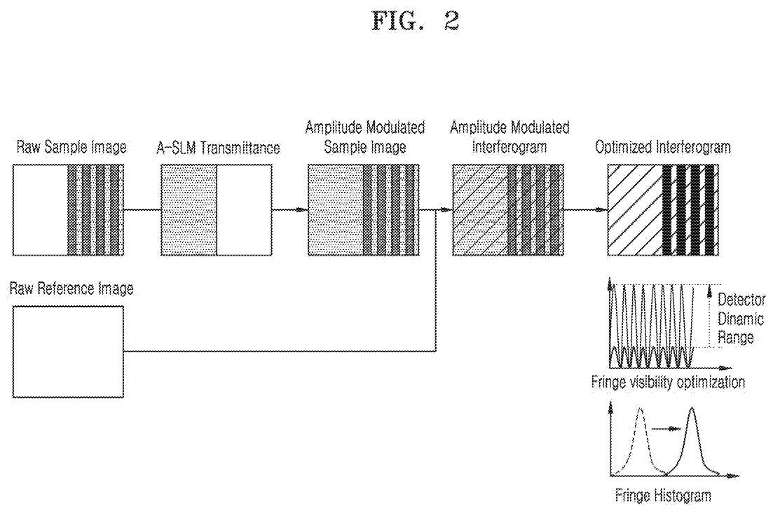

FIG. 2 is a diagram illustrating a process performed by a metrology and inspection apparatus according to one or more embodiments. The process will be described with reference to FIG. 1.

In the case of a sample of 3D memory for each process operation or an optical device of flat optics, an arrangement of structures with relatively large differences in transmission, reflection, and absorbance of a metal or absorber in a peripheral region of a chip may occur locally and relatively frequently within one image region. In addition, even within one nanostructure cell region, the differences in transmission, reflection, or absorbance may change relatively rapidly. Accordingly, a brightness difference may be relatively large within one image region, such as a brightness difference between a left region and a right region is relatively large in a raw sample image of FIG. 2. In this case, setting interference conditions between signal light and reference light according to transmittance or reflectance of a sample surface may cause poor visibility of an interference pattern on another region with a large difference in transmittance or reflectance, which results in poor SNR and deterioration of measurement precision, making it difficult to utilize an interferometer in metrology and inspection.

Therefore, the light transmitted through the sample 300 of FIG. 1 may be modulated by transmitting through the SLM 400 (A-SLM transmittance), so that the brightness of a partial region (e.g., the right region) may be adjusted, as in the amplitude modulated sample image of FIG. 2, and global optimization may be performed on regions with a relatively large brightness difference at a target brightness. Thereafter, the light transmitted through the sample 300 and the reference light may form an interference pattern through the interferometer 500 of FIG. 1, an amplitude modulated interferogram may be obtained therefrom, and an optimized interferogram may be obtained from the amplitude modulated interferogram. Accordingly, the overall contrast of fringe visibility may be improved, an SNR may be improved, and measurement accuracy may be improved.

However, embodiments are not limited thereto, and the brightness distribution may be adjusted on at least one of planes corresponding to an image of the signal light transmitted through the sample 300 and an image of the sample 300 on the path of the reference light. For example, at least one of an image brightness distribution of the sample 300 or a brightness distribution of the reference light may be adjusted by the SLM 400. For example, when the detector 600 generates an interference pattern of the signal light and the reference light, the brightness distribution of the reference light may be adjusted to maximize contrast of fringe visibility in each local region where the brightness distribution of the signal light changes.

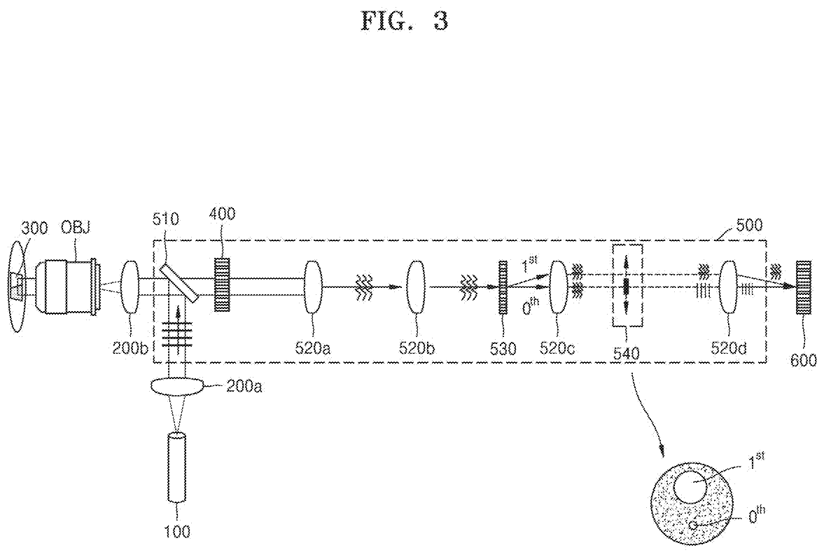

FIG. 3 is a diagram illustrating a detailed configuration of a metrology and inspection apparatus according to one or more embodiments. The metrology and inspection apparatus will be described with reference to FIG. 1. The interferometer 500 of FIG. 3 may be a common-path interferometer in which signal light and reference light move along the same path. The common-path interferometer has the advantage of being more robust to vibration and may be suitable for the metrology and inspection apparatus. The interferometer 500 may include, for example, at least one of a beam splitter 510, a plurality of lenses 520a, 520b, 520c, and 520d, a diffraction grating 530, and/or a spatial filter 540. Here, the sample 300 may be a reflective sample, and the SLM 400 may be a transmissive SLM.

Referring to FIG. 3, light emitted from the light source 100 may be converted into parallel light through an illumination optical system (e.g., a collimating lens 200a) and incident on the beam splitter 510 of the interferometer 500, and the light incident on the beam splitter 510 may be reflected and radiated and/or transmitted to the sample 300 through an illumination optical system (e.g., a condensing lens 200b) and an objective lens OBJ. When a relatively high-resolution inspection is performed, the objective lens OBJ may have a high aperture (NA>~0.5). When an equal inspection of a wide region is performed, the objective lens OBJ may have a low aperture (NA<~0.1). The light radiated and/or transmitted to the sample 300 may be reflected and incident on the SLM 400 through the objective lens OBJ, the condensing lens 200b, and the beam splitter 510.

The SLM 400 may be disposed on an image plane of the sample 300, and a brightness distribution of an image of the sample 300 may be modulated by the SLM 400. The light which is transmitted through the SLM 400 and of which intensity is modulated may then sequentially pass through the first lens 520a, the second lens 520b, the diffraction grating 530, the third lens 520c, the spatial filter 540, and the fourth lens 520d to be incident on the detector 600.

The first lens 520a may be, for example, a condensing lens, the second lens 520b may be, for example, a tube lens, and the diffraction grating 530 may be provided on the image plane. The diffraction grating 530 may separate the light modulated by the SLM 400 into zero-order diffracted light and first-order diffracted light. For example, the third lens 520c and the fourth lens 520d may be included in a relay optical system. The relay optical system may be, for example, a 4 f system to perform Fourier transformation on the image based on the third lens 520c and the fourth lens 520d. The spatial filter 540 may be provided on a Fourier plane of the 4 f system.

The spatial filter 540 may be provided to have a relatively small aperture through which the zero-order diffracted light transmits so that a low spatial frequency component passes to form reference light such as plane waves (reference light), and to have a relatively large aperture through which the first-order diffracted light transmits so that a high spatial frequency component to maintain sample light (signal light).

The detector 600 may detect an interference pattern formed by the reference light and the signal light.

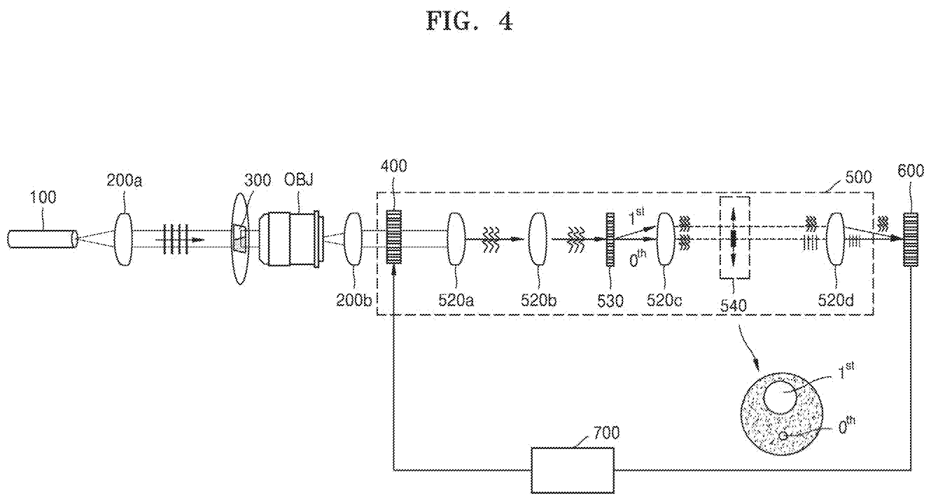

FIG. 4 is a diagram illustrating a detailed configuration of a metrology and inspection apparatus according to one or more other embodiments. The differences will be mainly described with reference to FIG. 3. The interferometer 500 of FIG. 3 may be a common-path interferometer in which signal light and reference light move along the same path. The interferometer 500 may include at least one of the plurality of lenses 520a, 520b, 520c, and 520d, the diffraction grating 530, and/or the spatial filter 540. Here, the sample 300 may be a transmissive sample, and the SLM 400 may be a transmissive SLM. The metrology and inspection apparatus may further include a controller 700.

Referring to FIG. 4, light emitted from the light source 100 may be radiated to the sample 300 through an illumination optical system (e.g., the collimating lens 200a). The light radiated and/or transmitted to the sample 300 may be transmitted through the sample 300 and be incident on the SLM 400 through the objective lens OBJ and the illumination optical system (e.g., the condensing lens 200b). The SLM 400 may be disposed on an image plane of the sample 300, and a brightness distribution of an image of the sample 300 may be modulated by the SLM 400.

The light which is transmitted through the SLM 400 and of which intensity is modulated may then sequentially pass through the first lens 520a, the second lens 520b, the diffraction grating 530, the third lens 520c, the spatial filter 540, and the fourth lens 520d to be incident on the detector 600.

The diffraction grating 530 may separate the light modulated by the SLM 400 into zero-order diffracted light and first-order diffracted light. The spatial filter 540 may be configured to allow plane waves among the zero-order diffracted light (reference light) to pass therethrough, and to allow the first-order diffracted light to pass therethrough as modulated light (signal light). The detector 600 may detect an interference pattern formed by the reference light and the signal light. The controller 700 may perform feedback control based on the interference pattern. The controller 700 may control the SLM 400 based on the obtained interference pattern.

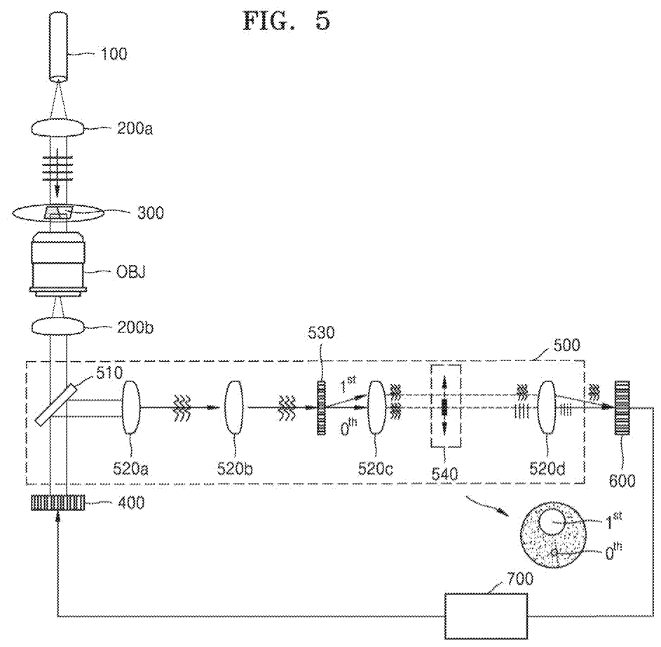

FIG. 5 is a diagram illustrating a detailed configuration of a metrology and inspection apparatus according to one or more other embodiments. The differences will be mainly described with reference to FIG. 3. The interferometer 500 of FIG. 5 may be a common-path interferometer in which signal light and reference light move along the same path. The interferometer 500 may include at least one of the beam splitter 510, the plurality of lenses 520a, 520b, 520c, and 520d, the diffraction grating 530, and/or the spatial filter 540. Here, the sample 300 may be a transmissive sample, and the SLM 400 may be a reflective SLM. The reflective SLM may be suitable for metrology and inspection in terms of an SNR and precision. The metrology and inspection apparatus may further include the controller 700.

Referring to FIG. 5, light emitted from the light source 100 may be radiated and/or transmitted to the sample 300 through an illumination optical system (e.g., the collimating lens 200a). Here, the sample 300 may be a transmissive sample. The light radiated to the sample 300 may be transmitted and incident on the beam splitter 510 of the interferometer 500 through the objective lens OBJ and an illumination optical system (e.g., the condensing lens 200b).

The light incident on the beam splitter 510 may be transmitted through the beam splitter 510 to be incident on the SLM 400. The SLM 400 may be disposed on an image plane of the sample 300, and a brightness distribution of an image of the sample 300 may be modulated by the SLM 400. Light reflected by the SLM 400 may be reflected by the beam splitter 510 to sequentially pass through the first lens 520a, the second lens 520b, the diffraction grating 530, the third lens 520c, the spatial filter 540, and the fourth lens 520d to be incident on the detector 600.

The detector 600 may detect an interference pattern formed by the reference light and the signal light. The controller 700 may perform feedback control based on the interference pattern. The controller 700 may control the SLM 400 based on the obtained interference pattern.

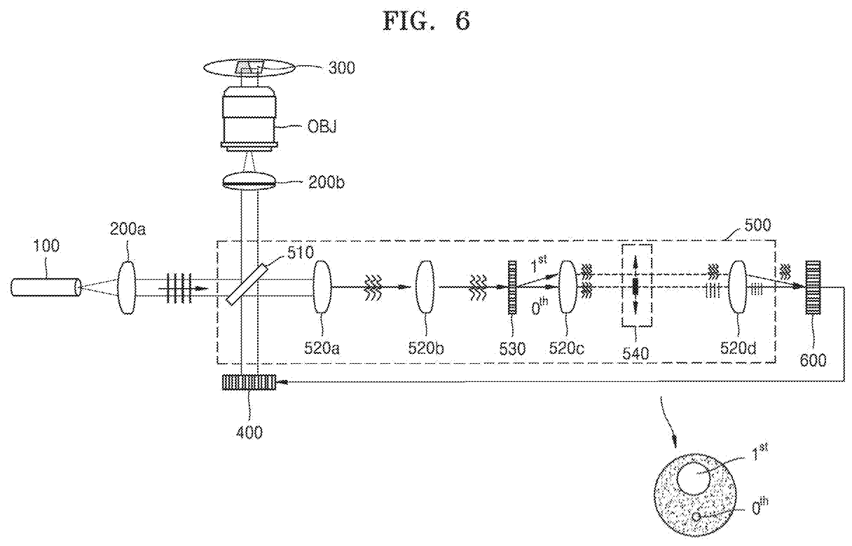

FIG. 6 is a diagram illustrating a detailed configuration of a metrology and inspection apparatus according to one or more other embodiments. The differences will be mainly described with reference to FIG. 3. The interferometer 500 of FIG. 6 may be a common-path interferometer in which signal light and reference light move along the same path. The metrology and inspection apparatus may further include the controller 700. Here, the sample 300 may be a reflective sample, and the SLM 400 may be a reflective SLM.

Referring to FIG. 6, light emitted from the light source 100 may be incident on the beam splitter 510 through an illumination optical system (e.g., the collimating lens 200a). The light incident on the beam splitter 510 may be reflected by the beam splitter 510 and radiated and/or transmitted to the sample 300 through an illumination optical system (e.g., the condensing lens 200b) and the objective lens OBJ. Here, the sample 300 may be a reflective sample. The light radiated and/or transmitted to the sample 300 may be reflected and then incident on the beam splitter 510 of the interferometer 500 through the objective lens OBJ and the illumination optical system (e.g., the condensing lens 200b).

The light incident on the beam splitter 510 may transmit through the beam splitter 510 to be incident on the SLM 400. The SLM 400 may be disposed on an image plane of the sample 300, and a brightness distribution of an image of the sample 300 may be modulated by the SLM 400. Here, the SLM 400 may be a reflective SLM. The light reflected by the SLM 400 may be reflected again by the beam splitter 510 to sequentially pass through the first lens 520a, the second lens 520b, the diffraction grating 530, the third lens 520c, the spatial filter 540, and the fourth lens 520d to be incident on the detector 600.

The detector 600 may detect an interference pattern formed by the reference light and the signal light. The controller 700 may perform feedback control based on the interference pattern. The controller 700 may control the SLM 400 based on the obtained interference pattern.

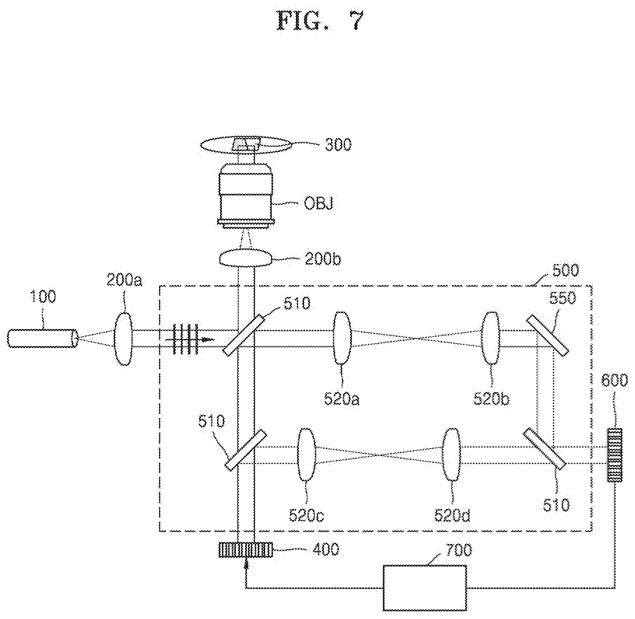

FIG. 7 is a diagram illustrating a detailed configuration of a metrology and inspection apparatus according to one or more other embodiments. The metrology and inspection apparatus will be described with reference to FIG. 1. The interferometer 500 of FIG. 7 may be a Mach-Zehnder interferometer. The interferometer 500 may include, for example, at least one of the plurality of beam splitters 510, the plurality of lenses 520a, 520b, 520c, and 520d, and/or a mirror 550. Here, the sample 300 may be a reflective sample, and the SLM 400 may be a reflective SLM.

Referring to FIG. 7, light emitted from the light source 100 may be converted into parallel light through an illumination optical system (e.g., the collimating lens 200a) and incident on the beam splitter 510 of the interferometer 500.

A first portion of the light incident on the beam splitter 510 may be transmitted through the beam splitter 510 and be reflected by the mirror 550 through the first lens 520a and the second lens 520b, and the light reflected by the mirror 550 may be reflected again by the beam splitter 510 to be incident on the detector 600 (reference light).

In addition, a second portion of the light incident on the beam splitter 510, that is the remaining portion of the light other than the first portion of the light, may be reflected by the beam splitter 510 and radiated and/or transmitted to the sample 300 through an illumination optical system (e.g., the condensing lens 200b) and the objective lens OBJ (signal light). The light radiated and/or transmitted to the sample 300 may be reflected to transmit through the objective lens OBJ, the illumination optical system (e.g., the condensing lens 200b), and the plurality of beam splitters 510 and then incident on the SLM 400. The SLM 400 may be disposed on an image plane of the sample 300, and a brightness distribution of an image of the sample 300 may be modulated by the SLM 400. The light modulated by the SLM 400 may be reflected by the beam splitter 510 and sequentially pass through the third lens 520c, the fourth lens 520d, and the beam splitter 510 to be incident on the detector 600.

### Signal Light

The first lens 520a and the second lens 520b may be included in a first relay optical system, and the third lens 520c and the fourth lens 520d may be included in a second relay optical system. A relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern.

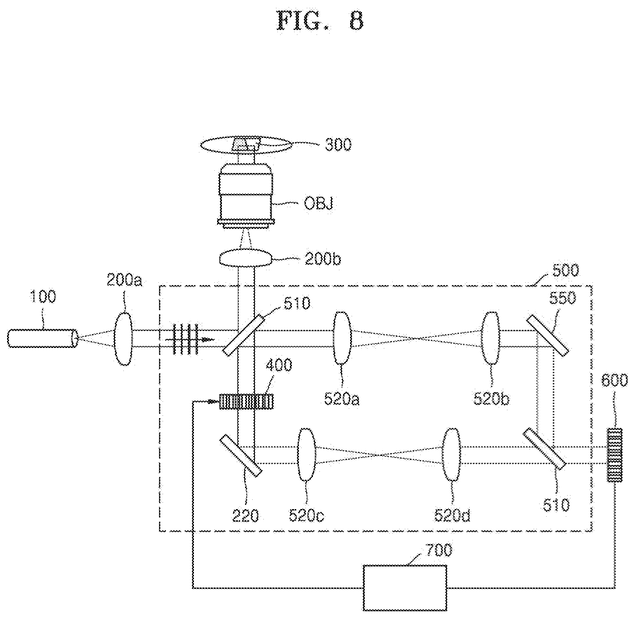

FIG. 8 is a diagram illustrating a detailed configuration of a metrology and inspection apparatus according to one or more other embodiments. The differences will be mainly described with reference to FIG. 7. The interferometer 500 of FIG. 8 may be a Mach-Zehnder interferometer. The interferometer 500 may include at least one of the plurality of beam splitters 510, the plurality of lenses 520a, 520b, 520c, and 520d, or the plurality of mirrors 550. Here, the sample 300 may be a reflective sample, and the SLM 400 may be a transmissive SLM. The metrology and inspection apparatus may further include the controller 700.

Referring to FIG. 8, light emitted from the light source 100 may be converted into parallel light through an illumination optical system (e.g., the collimating lens 200a) and incident on the beam splitter 510 of the interferometer 500.

A first portion of the light incident on the beam splitter 510 may be transmitted through the beam splitter 510 and be reflected by the mirror 550 through the first lens 520a and the second lens 520b, and the light reflected by the mirror 550 may be reflected again by the beam splitter 510 to be incident on the detector 600 (reference light).

In addition, a second portion of the light incident on the beam splitter 510, that is the remaining portion of the light other than the first portion of the light, may be reflected by the beam splitter 510 and radiated and/or transmitted to the sample 300 through an illumination optical system (e.g., the condensing lens 200b) and the objective lens OBJ. The light radiated and/or transmitted to the sample 300 may be reflected to transmit through the objective lens OBJ, the illumination optical system (e.g., the condensing lens 200b), and the plurality of beam splitters 510 and then incident on the SLM 400. The SLM 400 may be disposed on an image plane of the sample 300, and a brightness distribution of an image of the sample 300 may be modulated by the SLM 400. Here, the SLM 400 may be a transmissive SLM. The light modulated by the SLM 400 may be reflected by the mirror 220 and sequentially pass through the third lens 520c, the fourth lens 520d, and the beam splitter 510 to be incident on the detector 600 (signal light).

The first lens 520a and the second lens 520b may be included in a first relay optical system, and the third lens 520c and the fourth lens 520d may be included in a second relay optical system. A relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern.

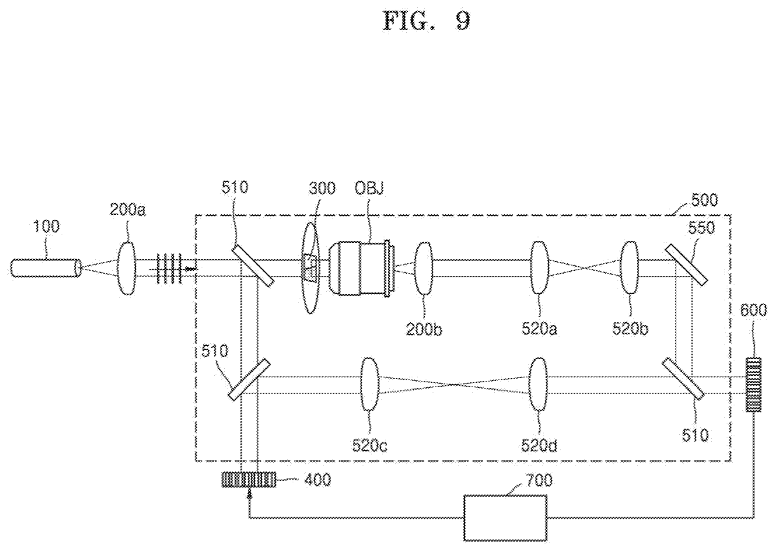

FIG. 9 is a diagram illustrating a detailed configuration of a metrology and inspection apparatus according to one or more other embodiments. The differences will be mainly described with reference to FIG. 7. The interferometer 500 of FIG. 9 may be a Mach-Zehnder interferometer. The interferometer 500 may include at least one of the plurality of beam splitters 510, the plurality of lenses 520a, 520b, 520c, and 520d, and/or the mirror 550. Here, the sample 300 may be a transmissive sample, and the SLM 400 may be a reflective SLM. The metrology and inspection apparatus may further include the controller 700.

Referring to FIG. 9, light emitted from the light source 100 may be converted into parallel light through an illumination optical system (e.g., the collimating lens 200a) and incident on the beam splitter 510 of the interferometer 500.

A first portion of the light incident on the beam splitter 510 may be transmitted through the beam splitter 510, the sample 300, the objective lens OBJ, an illumination optical system (e.g., the condensing lens 200b), the first lens 520a, and the second lens 520b, and then be reflected by the mirror 550, and the light reflected by the mirror 550 may be reflected again by the beam splitter 510 to be incident on the detector 600 (signal light).

In addition, a second portion of the light incident on the beam splitter 510, that is the remaining portion of the light other than the first portion of the light, may be reflected by the beam splitter 510 to be incident on the SLM 400. The SLM 400 is on an optical path of reference light on the entire interferometer, but may be disposed at a position corresponding to an image plane of the sample 300. A brightness distribution of an image of the reference light may be modulated by the SLM 400. The light modulated by the SLM 400 may be reflected again by the beam splitter 510 after being reflected, and sequentially pass through the third lens 520c, the fourth lens 520d, and the beam splitter 510 to be incident on the detector 600 (reference light).

The first lens 520a and the second lens 520b may be included in a first relay optical system, and the third lens 520c and the fourth lens 520d may be included in a second relay optical system. A relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern. In this case, when the detector 600 forms the interference pattern with the signal light, the controller 700 may adjust the brightness distribution of the reference light to maximize the contrast of fringe visibility in each local region where a brightness distribution of the signal light changes.

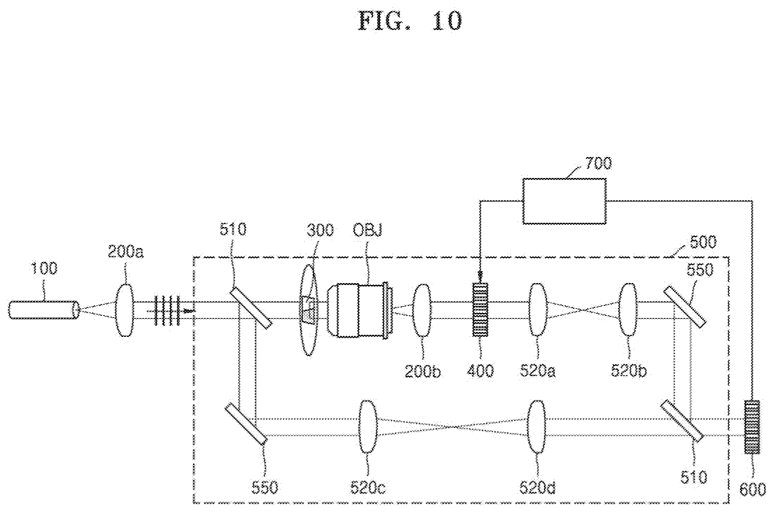

FIG. 10 is a diagram illustrating a detailed configuration of a metrology and inspection apparatus according to one or more other embodiments. The differences will be mainly described with reference to FIG. 7. The interferometer 500 of FIG. 10 may be a Mach-Zehnder interferometer. The interferometer 500 may include at least one of the plurality of beam splitters 510, the plurality of lenses 520a, 520b, 520c, and 520d, and the plurality of mirrors 550. Here, the sample 300 may be a transmissive sample, and the SLM 400 may be a transmissive SLM. The metrology and inspection apparatus may further include the controller 700.

Referring to FIG. 10, light emitted from the light source 100 may be converted into parallel light through an illumination optical system (e.g., the collimating lens 200a) and incident on the beam splitter 510 of the interferometer 500.

A first portion of the light incident on the beam splitter 510 may be transmitted through the sample 300, the objective lens OBJ, and an illumination optical system (e.g., the condensing lens 200b) and then be incident on the SLM 400. The SLM 400 may be disposed an image plane of the sample 300. The SLM 400 may modulate a brightness distribution of an image of the sample 300. The light modulated by the SLM 400 may sequentially transmit through the SLM 400, the first lens 520a, and the second lens 520b, and then be reflected by the mirror 550 and the beam splitter 510 to be incident on the detector 600 (signal light).

In addition, a second portion of the light incident on the beam splitter 510, that is the remaining portion of the light other than the first portion of the light, may be reflected again by the mirror 550 and then sequentially transmit through the third lens 520c, the fourth lens 520d, and the beam splitter 510 to be incident on the detector 600 (reference light).

The first lens 520a and the second lens 520b may be included in a first relay optical system, and the third lens 520c and the fourth lens 520d may be included in a second relay optical system. A relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern.

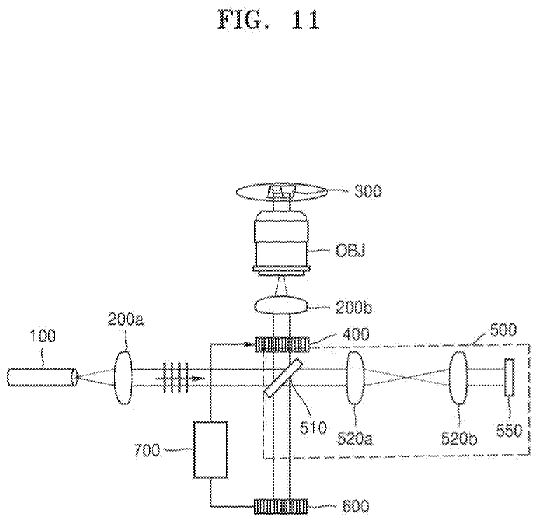

FIG. 11 is a diagram illustrating a detailed configuration of a metrology and inspection apparatus according to one or more other embodiments. The metrology and inspection apparatus will be described with reference to FIG. 1. The interferometer 500 of FIG. 11 may be a Michelson interferometer. The interferometer 500 may include, for example, at least one of the beam splitter 510, the plurality of lenses 520a and 520b, and/or the mirror 550. Here, the sample 300 may be a reflective sample, and the SLM 400 may be a transmissive SLM.

Referring to FIG. 11, light emitted from the light source 100 may be converted into parallel light through an illumination optical system (e.g., the collimating lens 200a) and incident on the beam splitter 510 of the interferometer 500.

A first portion of the light incident on the beam splitter 510 may transmit through the beam splitter 510 and be reflected by the mirror 550 through the first lens 520a and the second lens 520b, and the light reflected by the mirror 550 may be reflected by the beam splitter 510 through the second lens 520b and the first lens 520a again to be incident on the detector 600 (reference light).

In addition, a second portion of the light incident on the beam splitter 510, that is the remaining portion of the light other than the first portion of the light, may be reflected by the beam splitter 510 and radiated and/or transmitted to the sample 300 through an illumination optical system (e.g., the condensing lens 200b) and the objective lens OBJ. The light radiated and/or transmitted to the sample 300 may be reflected and incident on the SLM 400 through the objective lens OBJ and the illumination optical system 200 again. The light incident on the SLM 400 may be modulated by the SLM 400 so that a brightness distribution of an image of the sample 300 may be modulated. The light modulated by the SLM 400 may sequentially transmit through the SLM 400 and the beam splitter 510 and be incident on the detector 600 (signal light).

The first lens 520a and the second lens 520b may be included in a relay optical system. The relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern.

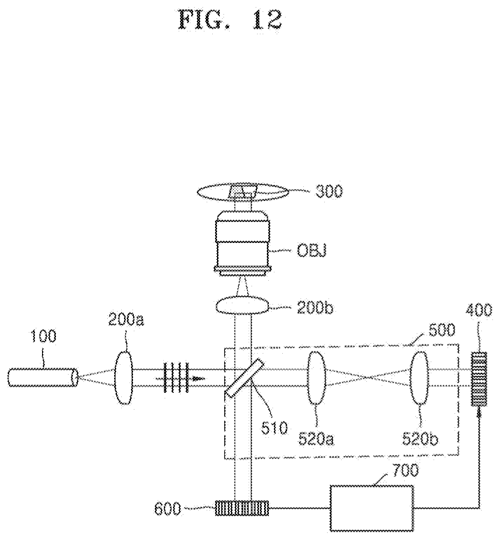

FIG. 12 is a diagram illustrating a detailed configuration of a metrology and inspection apparatus according to one or more other embodiments. The metrology and inspection apparatus will be described with reference to FIG. 11. The interferometer 500 of FIG. 12 may be a Michelson interferometer. The interferometer 500 may include, for example, at least one of the beam splitter 510 or the plurality of lenses 520a and 520b. The sample 300 may be a reflective sample, and the SLM 400 may be a reflective SLM.

Referring to FIG. 12, light emitted from the light source 100 may be converted into parallel light through an illumination optical system (e.g., the collimating lens 200a) and incident on the beam splitter 510 of the interferometer 500.

A first portion of the light incident on the beam splitter 510 may transmit through the beam splitter 510 to be incident on the SLM 400 through the first lens 520a and the second lens 520b, and the SLM 400 may be disposed at a position corresponding to an image plane of the sample 300 on the interferometer. The SLM 400 may modulate a brightness distribution of reference light. The light modulated by the SLM 400 may be reflected by the SLM 400 and incident on the beam splitter 510 through the second lens 520b and the first lens 520a again (reference light).

In addition, a second portion of the light incident on the beam splitter 510, that is the remaining portion of the light other than the first portion of the light, may be reflected by the beam splitter 510 and radiated and/or transmitted to the sample 300 through an illumination optical system (e.g., condensing lens 200b) and the objective lens OBJ. The light radiated and/or transmitted to the sample 300 may be reflected to transmit through the beam splitter 510 through the objective lens OBJ and the illumination optical system 200 again and then be incident on the detector 600 (reference light).

The first lens 520a and the second lens 520b may be included in a relay optical system. The relay optical system may be, for example, a 4 f system.

The detector 600 may detect an interference pattern formed by the reference light and the signal light. The controller 700 may perform feedback control based on the interference pattern. The controller 700 may control the SLM 400 based on the obtained interference pattern. In this case, when the detector 600 forms the interference pattern with the signal light, the controller 700 may adjust the brightness distribution of the reference light to maximize the contrast of fringe visibility in each local region where a brightness distribution of the signal light changes.

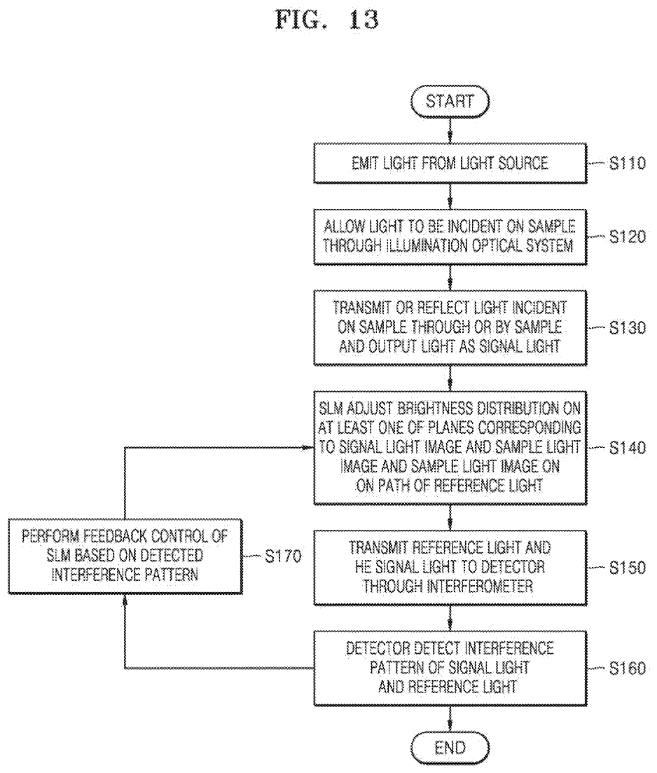

FIG. 13 is a flowchart illustrating a metrology and inspection method according to one or more embodiments. The metrology and inspection method will be described with reference to FIG. 1.

Referring to FIG. 13, in the metrology and inspection method according to one or more embodiments, light may be emitted from the light source 100 (S110) and then incident on the sample 300 through the illumination optical system 200 (S120). The light incident on the sample 300 may be transmitted through the sample 300 or be reflected by the sample 300 to be output as signal light (S130). A brightness distribution on a plane corresponding to an image of the sample 300 may be adjusted by the SLM 400 on at least one path of the signal light or the reference light (S140). For example, at least one of an image brightness distribution of the sample 300 or the brightness distribution of the reference light may be modulated by the SLM 400. Thereafter, the relative brightness distribution may be adjusted so that the reference light and the signal light may be transmitted to the detector 600 through the interferometer 500 (S150), and the detector 600 may detect an interference pattern of the signal light and the reference light (S160).

In addition, the controller 700 may perform feedback control of the SLM 400 based on the interference pattern of the signal light and the reference light (S170). The controller 700 may control the output amplitude of each pixel of the SLM 400 so that the brightness distribution of the interference pattern is generally uniform or the contrast of fringe visibility of each region is maximized based on the interference pattern of the signal light and the reference light obtained from the detector 600.

The embodiments described above are summarized as follows.

According to one or more embodiments, the optical system for metrology and inspection may include a light source, an interferometer configured to separate light emitted from the light source into reference light and signal light which is transmitted through a sample or reflected by the sample, an SLM provided on an image plane of the sample in an optical path of the reference light or the signal light and configured to modulate a brightness distribution of local light of the image plane, and a detector configured to detect an interference pattern of the signal light and the reference light.

The SLM may include an amplitude-SLM (A-SLM).

The interferometer may include a common-path interferometer.

The interferometer may include a common-path interferometer, and the common-path interferometer may include a diffraction grating and a spatial filter.

The interferometer may include a Mach-Zehnder interferometer.

The interferometer may include a Michelson interferometer.

The optical system may further include an illumination optical system configured to radiate light emitted from the light source to the sample, and the illumination optical system may include a collimating lens.

The interferometer may include a relay optical system, and the relay optical system may include a 4 f system.

The sample may include any one of a reflective sample and a transmissive sample, and the SLM may include any one of a transmissive SLM and a reflective SLM.

An operation of the SLM may be controlled based on the interference pattern.

According to one or more embodiments, the metrology and inspection apparatus may include a light source, an interferometer configured to separate light emitted from the light source into reference light and signal light which is transmitted through a sample or reflected by the sample, an SLM provided on an image plane of the sample in an optical path of the reference light or the signal light and configured to modulate a brightness distribution of local light of the image plane, a detector configured to detect an interference pattern of the signal light and the reference light, and a controller configured to control an operation of the SLM based on the interference pattern.

The SLM may include an amplitude-SLM (A-SLM).

The interferometer may include any one of a common-path interferometer, a Mach-Zehnder interferometer, and a Michelson interferometer.

The metrology and inspection apparatus may further include an illumination optical system configured to radiate light emitted from the light source to the sample, and the illumination optical system may include a collimating lens.

The interferometer may include a relay optical system, and the relay optical system may include a 4 f system.

The sample may include any one of a reflective sample and a transmissive sample, and the SLM may include any one of a transmissive SLM and a reflective SLM.

According to one or more embodiments, the metrology and inspection method may include emitting light from a light source, allowing the light emitted from the light source to be incident on a sample through an illumination optical system, transmitting or reflecting the light incident on the sample through or by the sample and outputting the light as signal light, adjusting, by an SLM, a brightness distribution of an image of the sample or reference light at a position corresponding to an image plane of the sample on an optical path of reference light, transmitting the reference light and the signal light to a detector through an interferometer, and detecting, by the detector, an interference pattern of the signal light and the reference light.

The metrology and inspection method may further include performing feedback control of the SLM based on the interference pattern.

The SLM may include an amplitude-SLM (A-SLM).

The interferometer may include any one of a common-path interferometer, a Mach-Zehnder interferometer, and a Michelson interferometer.

According to one or more embodiments, the optical system for metrology and inspection using an interferometer includes an SLM, thereby improving the overall contrast of fringe visibility, improving an SNR, and improving measurement accuracy.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An optical system for metrology and inspection, the optical system comprising:
a light source configured to emit light;
an interferometer configured to separate the light emitted from the light source into reference light and signal light which is transmitted through a sample or reflected by the sample;
a spatial light modulator (SLM) on a plane corresponding to an image plane of the sample in an optical path of the reference light or an optical path of the signal light, the SLM being configured to modulate at least one of a brightness distribution of an image of the sample or a brightness distribution of the reference light; and
a detector configured to detect an interference pattern of the signal light and the reference light.

2. The optical system of claim 1, wherein the SLM comprises an amplitude-SLM (A-SLM).

3. The optical system of claim 1, wherein the interferometer comprises a common-path interferometer.

4. The optical system of claim 1, wherein the interferometer comprises a common-path interferometer, and the common-path interferometer comprises a diffraction grating and a spatial filter.

5. The optical system of claim 1, wherein the interferometer comprises a Mach-Zehnder interferometer.

6. The optical system of claim 1, wherein the interferometer comprises a Michelson interferometer.

7. The optical system of claim 1, further comprising:
an illumination optical system configured to transmit the light emitted from the light source to the sample,
wherein the illumination optical system comprises a collimating lens.

8. The optical system of claim 1, wherein the interferometer comprises a relay optical system, and
wherein the relay optical system comprises a 4 f system configured to perform Fourier transformation.

9. The optical system of claim 1, wherein the sample comprises one of a reflective sample or a transmissive sample, and
wherein the SLM comprises one of a transmissive SLM or a reflective SLM.

10. The optical system of claim 1, wherein the SLM is configured to be controlled based on the interference pattern.

11. A metrology and inspection apparatus comprising:
a light source configured to emit light;
an interferometer configured to separate the light emitted from the light source into reference light and signal light which is transmitted through a sample or reflected by the sample;
a spatial light modulator (SLM) on a plane corresponding to an image plane of the sample in an optical path of the reference light or an optical path of the signal light, the SLM being configured to modulate at least one of a brightness distribution of an image of the sample or a brightness distribution of the reference light;
a detector configured to detect an interference pattern of the signal light and the reference light; and
a processor configured to control an operation of the SLM based on the interference pattern.

12. The metrology and inspection apparatus of claim 11, wherein the SLM comprises an amplitude-SLM (A-SLM).

13. The metrology and inspection apparatus of claim 11, wherein the interferometer comprises one of a common-path interferometer, a Mach-Zehnder interferometer, or a Michelson interferometer.

14. The metrology and inspection apparatus of claim 11, further comprising:
an illumination optical system configured to transmit light emitted from the light source to the sample,
wherein the illumination optical system comprises a collimating lens.

15. The metrology and inspection apparatus of claim 11, wherein the interferometer comprises a relay optical system, and
wherein the relay optical system comprises a 4 f system configured to perform Fourier transformation.

16. The metrology and inspection apparatus of claim 11, wherein the sample comprises one of a reflective sample or a transmissive sample, and
wherein the SLM comprises one of a transmissive SLM or a reflective SLM.

17. A metrology and inspection method comprising:
emitting, by a light source, light;
transmitting, through an illumination optical system, the light emitted from the light source to be incident on a sample;
transmitting the light incident on the sample through the sample or reflecting the light incident on the sample by the sample, and outputting the light as signal light;
adjusting, by a spatial light modulator (SLM), a brightness distribution on at least one of a plane of an image of the sample or a plane an image of reference light corresponding thereto;
transmitting, by an interferometer, the reference light and the signal light to a detector; and
detecting, by the detector, an interference pattern of the signal light and the reference light.

18. The metrology and inspection method of claim 17, further comprising:
performing feedback control of the SLM based on the interference pattern.

19. The metrology and inspection method of claim 17, wherein the SLM comprises an amplitude-SLM (A-SLM).

20. The metrology and inspection method of claim 17, wherein the interferometer comprises one of a common-path interferometer, a Mach-Zehnder interferometer, or a Michelson interferometer.
